(19) United States
(12) Patent Application Publication
(10) Pub. No.: US 2011/0192437 A1
(43) Pub. Date: Aug. 11, 2011

(54) PROTECTIVE SHELTER

(76) Inventor: Paul Adams, Enumclaw, WA (US)

(21) Appl. No.: 13/086,995

(22) Filed: Apr. 14, 2011

Related U.S. Application Data
(63) Continuation-in-part of application No. 12/058,514, filed on Mar. 28, 2008, now Pat. No. 7,938,134.

(51) Int. Cl. E04H 15/36; F16B 7/08; B23P 11/00

(52) U.S. Cl. 135/124; 403/83; 29/428; 29/525.01

(57) ABSTRACT

A protective shelter that may be used to protect observers, players, and others from inclement weather during a sporting event, for example, includes an arcuate-shaped, flexible cover with side portions configured to receive side frame members, which in turn are connected to elongated cover support members coupled to the cover. The various frame members and cover support members may be connected with a number of different types of couplers. In addition, a majority of the side frame members and support members may remain coupled to the flexible cover after the protective shelter has been disassembled and placed in a transportable configuration.

### PRIORITY CLAIM

This application is a continuation-in-part of co-pending, commonly-owned U.S. patent application Ser. No. 12/058,514 filed Mar. 28, 2008 and wherein the subject matter of that application is incorporated herein by reference in its entirety.

### FIELD OF THE INVENTION

This invention relates generally to a protective shelter and methods of assembling the same, and more specifically to protective shelters that may be readily assembled, disassembled and transported by a person.

### BACKGROUND OF THE INVENTION

Conventional shelters for protection against various weather-related elements, such as sun, rain, wind, snow, etc. may come in a variety of shapes, sizes, and have varying degrees of complexity related to the assembly or disassembly of the shelter. By way of example, U.S. Pat. No. 4,355,650 to Beaudry describes a conventional shelter that takes the form of a portable and collapsible shelter having a plurality of support ribs or bows which are pivotally mounted to a hub at each end thereof. Each rib is made up of at least three completely separable pieces. The fabric covering of the structure provides compressive forces to the bows to maintain the assembled condition of the bows.

When erected, the structure is maintained in an open position by a pair of side braces positioned at the vertical sides of the structure. A first side brace is pivotally attached to the rib which rests on the ground; a second brace is pivotally attached to the rib forming the entrance to the structure. The braces are pivotally attached to each other at their other ends by a rivet. A keyhole slot is provided in the center rib for purposes of receiving the head of the rivet attaching the two braces to each other. The large portion of the keyhole slot is positioned closest to the hub while the smaller elongated portion of the slot extends away from the hub. When the ribs or bows are fully fanned out, the head of the aforementioned rivet fits within the elongated portion of the keyhole slot and the braces form an angle with each other with the apex of the angle extending away from the hub.

The outer covering of the shelter is then snap fastened to the first and last bows. The resulting tautness of the outer covering provides a force which tends to cause the bows to collapse. Such force, however, in conjunction with the angle formed by the braces, firmly locks the rivet head within the elongated portion of the keyhole slot and thereby prevents the structure from collapsing.

A combination digging tool and anchor prevents the structure from being moved by the wind when erected. A tie rod is pivotally attached to each hub and extends therefrom into the ground. A small trench is dug into the ground at the location of the hub with the aid of the combination tool. When an appropriate depth is achieved, the tool is engaged with the tie rod, forming an inverted “T” within the trench. The trench is then backfilled with earth or sand which buries the anchor within the covered over trench.

During assembly, the bows are connected to form five “U”-shaped bows. Next, the bows are fully fanned out by applying a force to the pinned braces in a direction away from the hub. The inherent collapsing action of the bows together with the angle formed by the braces causes a connection rivet to maintain its position at the end of a keyhole slot, which end is furthermost away from the hub. At this point of the erection sequence of shelter, the fabric covering is draped over the framework of shelter and then snap fitted to one or more bows. The interrelating forces of the bows, the fabric covering, and the braces as they act and react with each other maintains the shelter in a fully erected position.

U.S. Pat. No. 7,178,540 to Eder describes an improved hub for a personal shelter or canopy. The hub includes a number of spherical rotating joint elements captured in a hub body. The joint elements provide rotational movement of canopy frame elements to allow easy opening and collapsing of a canopy frame and cover. Two canopy hubs are preferably connected along a common axis by a rigid cross bar. Each hub may be formed by molding in high-density plastic and combined with stub arms to facilitate subsequent assembly of a completed canopy.

### SUMMARY OF THE INVENTION

The present invention relates to a protective shelter. More specifically and in one embodiment, the present invention relates to a transportable protective shelter having an arcuate-shaped, flexible cover with side portions configured to receive side frame members, which in turn are connected to elongated cover support members coupled to the cover. The various frame members and support members may be connected with different types of couplers or connectors. In one embodiment, only several of the members are removable while the others remain with the cover and may be folded up in situ.

In accordance with an aspect of the invention, a protective shelter includes an arcuate-shaped cover made from a flexible material, the cover extending from a first side portion to a second side portion; two side frames each respectively coupled to the first and second side portions of the cover, each side frame having a removable, arcuate-shaped structural member coupled to two radially extending structural members each fixed to the cover, each side frame further having a diagonal member with a first end coupled to a central hub member and a second end coupled to the arcuate-shaped structural member; an elongated top-front structural member extending from the one side frame to the other side frame and having a first pivot connector, the top-front structural member fixed to the cover to provide horizontal tension to the flexible material of the cover and to maintain the side frames in a spaced apart relationship from one another when the shelter is in an operating configuration, the first pivot connector having a pinned connection for permitting the elongated top-front structural member to be folded; and an elongated bottom-rear structural member extending from the one side frame to the other side frame and having second pivot connector, the bottom-back structural member coupled to the cover to provide horizontal tension to the flexible material of the cover and to maintain the side frames in a spaced apart relationship from one another when the shelter is in the operating configuration, the second pivot connector having a pinned connection for permitting the elongated bottom-back structural member to be folded.

In accordance with another aspect of the invention, a protective shelter includes an arcuate-shaped cover having a top portion that extends continuously into a back portion, the cover made from a flexible material, the cover extending substantially horizontally from a first side portion to a second side portion; two side frames each respectively coupled to the first and second side portions of the cover, each side frame having an arcuate-shaped structural member coupled to two radially extending structural members, the arcuate-shaped structural member cooperating with the respective side portion of the cover to provide circumferential tension to the flexible material of the cover, the two radially extending structural members coupled to and extending from a central hub, each side frame further having an intermediate structural member having a first end coupled to the central hub and a second end coupled to the arcuate-shaped structural member, the intermediate structural member circumferentially located between the two radially extending structural members; an elongated top-front structural member extending from the one side frame to the other side frame, the top-front structural member coupled to the cover to provide horizontal tension to the flexible material of the cover and to maintain the side frames in a spaced apart relationship from one another; and an elongated bottom-rear structural member extending from the one side frame to the other side frame, the bottom-back structural member coupled to the cover to provide horizontal tension to the flexible material of the cover and to maintain the side frames in a spaced apart relationship from one another.

In accordance with another aspect of the invention, a method of assembling a protective shelter includes the steps of (1) connecting an elongated top-front structural member to the front edge of the flexible cover and an elongated bottom-back structural member to the back edge of the flexible cover, the top-front and bottom-back structural members configured to tension the cover in a direction substantially parallel to a longitudinal axis of at least one of the top-front and bottom-back structural members; (2) coupling a first arcuate-shaped structural member to one side edge of the cover and to the top-front and bottom-back structural members; (3) coupling a second arcuate-shaped structural member to the other side edge of the cover and to the top-front and bottom-back structural members; (4) rotating the top-front structural member away from the bottom-back structural member about a shelter rotation axis extending horizontally through first and second central hubs corresponding to the respective first and second arcuate-shaped structural members; and (5) coupling a tensioning member with the flexible cover.

In accordance with yet another aspect of the invention, a protective shelter includes an arcuate-shaped cover made from a flexible material, the cover extending from a first side portion to a second side portion; a framework having two side frame assemblies and structural members extending from the one side frame assembly to the other side frame assembly, each side frame assembly having a diagonal member spaced from front-side and bottom-side structural members, the framework assembleable to make the cover taut; and at least one side brace assembly having two compression members coupled to a slide connector that is slideably moveable along the diagonal member, the slide connector moveable from an unlocked position to a locked position.

In accordance with still yet another aspect of the invention, a protective shelter includes an arcuate-shaped cover made from a flexible material, the cover extending from a first side portion to a second side portion; a framework having two side frame assemblies and structural members extending from the one side frame assembly to the other side frame assembly, the framework further having, the framework assembleable to make the cover taut; and at least one connector assembly having abutting sleeves, each sleeve configured to receive one of the structural members, the sleeves pivotally coupled together, the connector assembly further having a grippable latch with a first end portion pivotally coupled to one of the sleeves and a second end portion pivotally coupled to the other sleeve.

In accordance with yet another aspect of the invention, a protective shelter includes an arcuate-shaped cover made from a flexible material, the cover extending from a first side portion to a second side portion; a framework having two side frame assemblies and structural members extending from the one side frame assembly to the other side frame assembly, each side frame assembly having at least one intermediate member in approximately the arcuate-shape of the cover, the framework assemble-able to make the cover taut; and at least one cross connector having a first channel attachable to one of the structural members and a second channel biasly attachable to the at least one intermediate member.

In accordance with yet another aspect of the invention, a connector assembly includes a first sleeve configured to receive a first structural member; a second sleeve configured to receive second structural member, the second sleeve abutting the first sleeve and pivotally coupled thereto; and a grippable latch with a first end portion pivotally coupled to one of the sleeves and a second end portion pivotally coupled to the other sleeve.

### BRIEF DESCRIPTION OF THE DRAWINGS

Preferred and alternative embodiments of the present invention are described in detail below with reference to the following drawings:

FIG. 1 is an isometric view of a protective shelter according to an embodiment of the present invention;

FIG. 2 is an isometric view of the protective shelter of FIG. 1 showing the locations of the various cover and side support members;

FIG. 3 is a side elevational view of a side frame of the protective shelter of FIG. 1;

FIG. 4 is an isometric view of the protective shelter of FIG. 1 showing the locations of the various connectors used in the shelter;

FIG. 5 is an isometric view of a slide-locking bent tongue connector according to an embodiment of the present invention;

FIG. 6 is an isometric view of a snap T-connector according to an embodiment of the present invention;

FIG. 7 is an isometric view of a snap saddle connector according to an embodiment of the present invention;

FIG. 8 is an isometric view of complex connector according to an embodiment of the present invention;

FIG. 9 is an isometric view of a tri-connector according to an embodiment of the present invention;

FIG. 10 is an isometric view of a straight tongue connector according to an embodiment of the present invention;

FIG. 11 is an isometric view of elbow-shaped saddle connector according to an embodiment of the present invention;

FIG. 12 is an isometric view of a shelter having a front flap according to another embodiment of the present invention;

FIG. 13 is an isometric view of a shelter having a anchoring devices according to another embodiment of the present invention;

FIG. 14 is an isometric view of a shelter having rear flaps according to another embodiment of the present invention;

FIG. 15 is an isometric view of a shelter having rear window panels according to another embodiment of the present invention;

FIG. 16 is a perspective view of a shelter having a cover over a framework according to an embodiment of the present invention;

FIG. 17 is a perspective view of the framework of FIG. 16;

FIG. 18A is side elevational view of a side frame having a side-brace assembly with a slide connector and compression members according to an embodiment of the present invention;

FIG. 18B is a schematic side elevational view of the side-brace assembly of FIG. 18A with a slide connector moved to an over-center position according to an embodiment of the present invention;

FIG. 19 is perspective view of the slide connector of FIG. 18A;

FIG. 20A is side elevational view of a connector assembly in a locked position according to an embodiment of the present invention;

FIG. 20B is side elevational view of a connector assembly in an open position according to an embodiment of the present invention;

FIG. 21 is a perspective of a sleeve of the connector assembly of FIG. 20B according to an embodiment of the present invention;

FIG. 22 is an exploded, perspective view of a latch of the connector assembly of FIG. 20B according to an embodiment of the present invention;

FIG. 23 is a perspective view of a cross connector according to an embodiment of the present invention;

FIG. 24 is a perspective view of a slide T-connector according to an embodiment of the present invention;

FIG. 25 is a perspective view of the framework of FIG. 17 in a fully assembled configuration according to an embodiment of the present invention;

FIG. 26 is a perspective view of the framework of FIG. 17 in a partially collapsed configuration according to an embodiment of the present invention; and

FIG. 27 is a perspective view of the framework of FIG. 17 in a fully collapsed configuration according to an embodiment of the present invention.

### DETAILED DESCRIPTION OF THE PREFERRED EMBODIMENT

As will be described in further detail below, at least one embodiment of the invention includes a protective shelter that may be used to protect observers, players, and others from inclement weather during a sporting event, for example, includes an arcuate-shaped, flexible cover with side portions configured to receive side frame members, which in turn are connected to elongated cover support members coupled to the cover. The various frame members and cover support members may be connected with a number of different types of couplers. In addition, a majority of the side frame members and support members may remain coupled to the flexible cover after the protective shelter has been disassembled and placed in a transportable configuration.

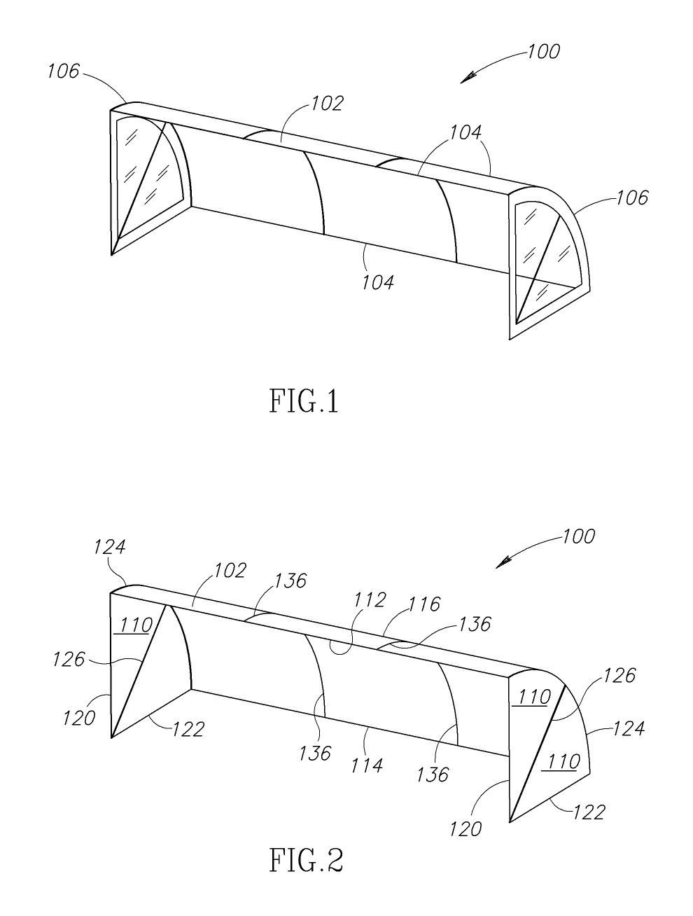

FIGS. 1-3 show a protective shelter 100 having a flexible cover 102 supported by a plurality of cover support members 104 and side frames 106 according to an illustrated embodiment of the present invention. The flexible cover 102 may take the form of a one-piece cover having an arcuate-shaped covering portion 108 and side covering portions 110. The arcuate shape of the covering portion 108 may approximately take the shape of, but is not limited to, a quarter-circle segment (e.g., 90 degrees from a back, bottom portion to a top, front portion) or larger angled segment. The cover 102 may be made from a variety of flexible materials, such as but not limited to, nylon taffeta, nylon oxford, rip stop nylon, Gore-Tex®, Nomex®, and other equivalent materials. Nevertheless, the cover 102, in its entirety, may be sufficiently light weight to be transported by a single person when the shelter 100 is placed in a transportable or carrying configuration, yet also sufficiently durable to be folded, rolled, pulled, and/or stretched while the shelter 100 is being set up in an operating configuration or being packaged into the transportable configuration.

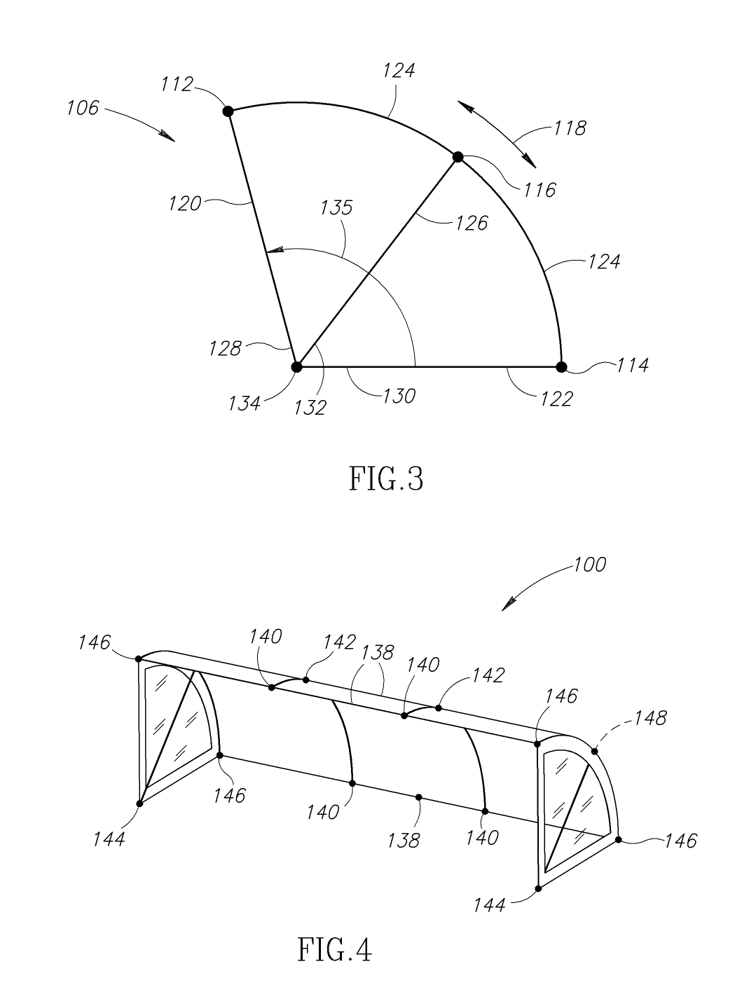

Now referring primarily to FIGS. 2 and 3, the plurality of cover support members 104 may include an elongated top-front structural member 112 and an elongated bottom-back structural member 114. In addition, the cover support members 104 may include one or more tensioning members 116 coupled to the cover 102 and located in a circumferentially intermediate position between the top-front structural member 112 and the bottom-back structural member 114 as best shown in FIG. 3, where the circumferential direction is indicated by a circumferential direction arrow 118.

The side frames 106 support the side covering portions 110 of the protective shelter 100. In one embodiment, each side frame 106 includes a front-side structural member 120, a bottom-side structural member 122, an arcuate or arch-shaped structural member 124, and at least one diagonal or radially-extending structural member 126. The front-side, bottom-side, and diagonal radially-extending members 120, 122, and 126 include respective first end portions 128, 130, and 132 each coupled to a hub device 134, which is schematically shown in FIG. 3 and is described in greater detail below. An angle 135 between the bottom-side radially-extending member 122 (i.e., horizontal) and the front-side radially-extending member 120 (i.e., vertical) may be in a range of about 75-140 degrees and preferably in a range of about 90-120 degrees. In a preferred embodiment, the angle 135 is about 110 degrees, which provides sufficient structural stability and an adequate overhang portion to protect occupants of the shelter from various types of weather.

In one embodiment, the protective shelter 100 with the top-front structural member 112, the bottom-back structural member 114 and the tensioning member 116 may be interconnected with arcuate or arch-shaped intermediate members 136. In the illustrated embodiment two intermediate members 136 are used, but this number may vary depending on the length of the shelter 100 and/or on the environment in which the shelter 100 is employed.

One or more of the members described above may take the form of lightweight, hollow, aluminum alloy members, advanced composite members, plastic members, or some equivalent thereof. Advanced composite members may include any type of structural fiber material combined with a resin, for example graphite fibers reinforced or embedded in an epoxy resin. Further, the members may take the form of poles, rods, or tubes that may or may not have a circular cross section. By way of example, the members may be segmented such that each segment is coupled to an adjacent segment and all the segments of a particular member are connected by a stretchable cord that extends through the hollow portion thereof. Alternatively stated, the members may be configured similar to and operate like segmented tent poles. In one embodiment, a number of the members may be fixed to the cover 102, for example bonded to or sewn into respective pockets of the cover 102. Fixing at least a number of members to the cover 102 may help reduce the number of loose parts that must be handled during assembly/disassembly of the shelter 100.

FIG. 4 schematically shows several different types of connectors and their locations with respect to the shelter 100. The connectors are used to join the various members described above with one another and/or with the cover 102. In one embodiment, the elongated top-front structural member 112, the elongated bottom-back structural member 114, and the tensioning member 116 may each be comprised of two or more members interconnected with a slide-locking bent tongue connector 138. The intermediate members 136 are coupled to the elongated top-front structural member 112 and the elongated bottom-back structural member 114 using snap T-connectors 140. The intermediate members 136 are coupled to the tensioning member 116 using snap saddle connectors 142. The front-side structural member 120 and the bottom-side structural member 122 are coupled together using a hub or complex connector 144. The elongated top-front structural member 112 and the elongated bottom-back structural member 114 are each coupled to the side frames 106 using tri-connectors 146. Likewise, the tensioning member 116 is coupled to the side frames 106 using a straight tongue connector 148 and an elbow-shaped saddle connector 150.

FIG. 5, by way of example, shows the slide-locking bent tongue connector 138 attaching two top-front structural members 112. The connector 138 includes bent-tongue portions 160 and a slide-locking collar 162. In the illustrated embodiment, two bent-tongue portions 160 are arranged in opposing directions such that they may be pin connected together through opening 164. Extending portions 166 may be bonded to the two top-front structural members 112. Removing a pin (not shown) from the connector 138 permits the shelter 100 to be folded. The slide lock collar 162 locks the two bent-tongue portions 160 together when the shelter 100 is in an operating configuration. The slide lock collar 162 provide structural support to the joint and functions to reduce flexing or opening of the joint.

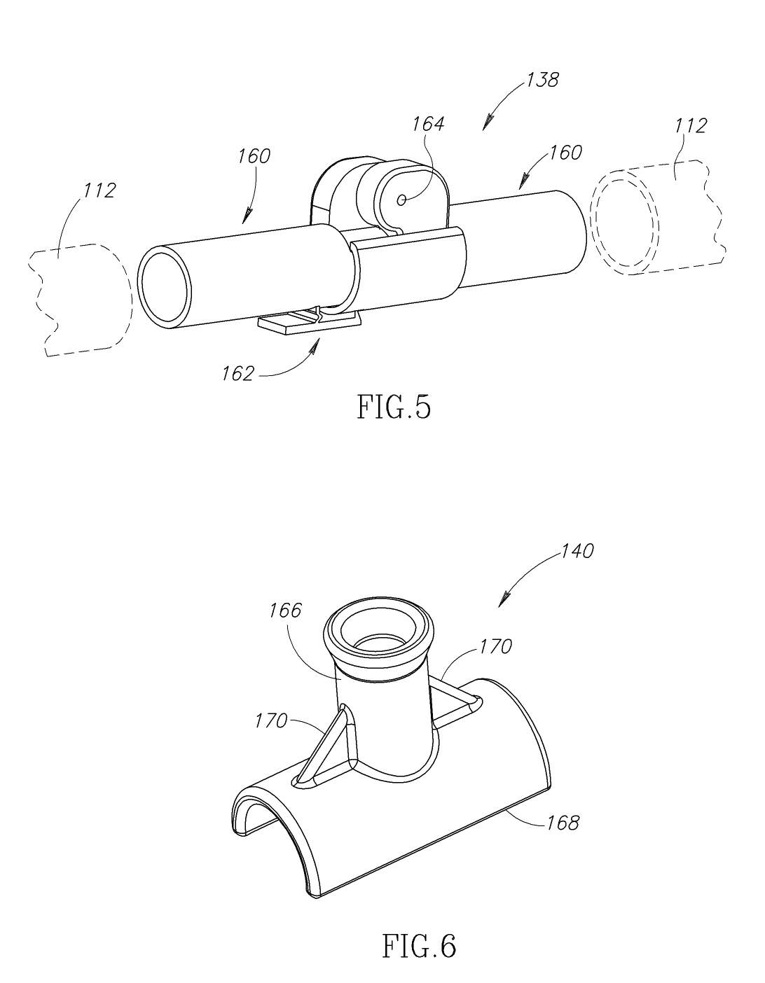

FIG. 6 shows, by way of example, the snap T-connector 140 used to couple the intermediate members 136 to the elongated top-front structural member 112 and the elongated bottom-back structural member 114. The snap T-connector 140 includes a pole or rod coupling portion 166 for engaging the intermediate member 136 and a saddle or snap portion 168 for engaging the top-front and bottom-back structural members 112, 114, respectively. For additional structural support, the snap T-connector 140 may include gussets or ribs 170 that extend between the rod coupling portion 166 and the snap portion 168.

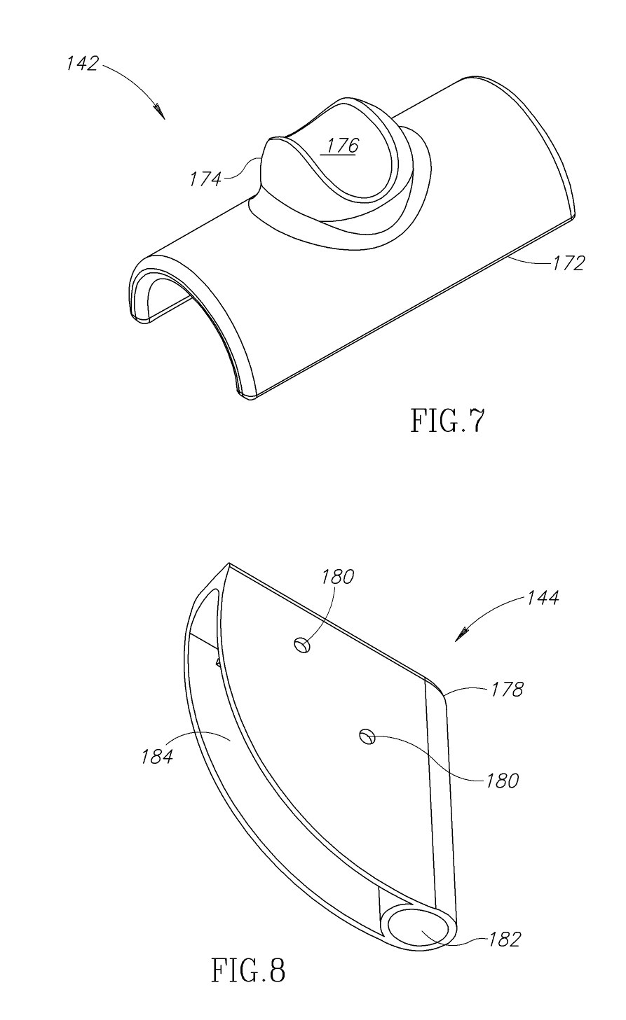

FIG. 7 shows, by way of example, the snap saddle 142 for coupling the intermediate members 136 to the tensioning member 116. The snap saddle 142 includes a snap portion 172 to receivably support a portion of the tensioning member 116 and a protuberance 174 extending from the snap portion 172. The protuberance 174 includes a contoured surface 176 configured to engage a portion of the intermediate member 136.

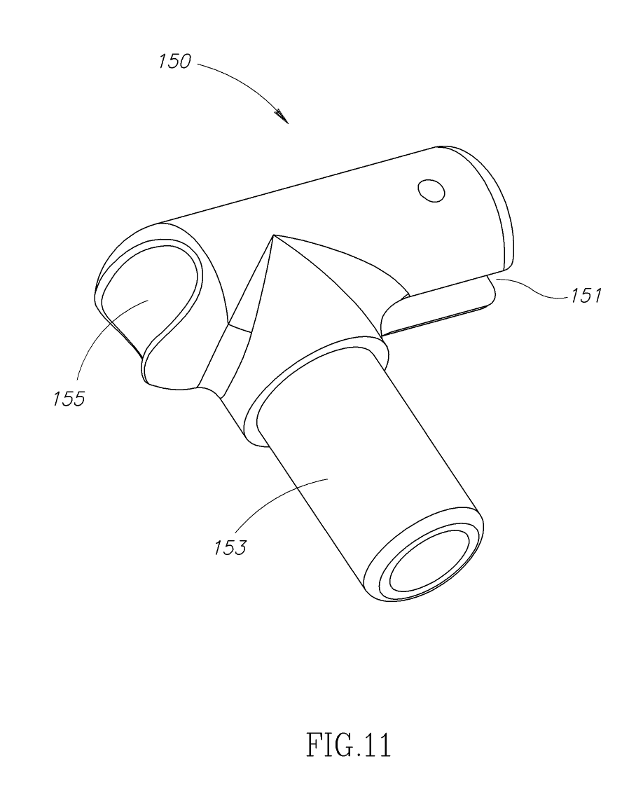

FIG. 8 shows, by way of example, the complex connector 144, which operates as a central hub for the side frames 106. The complex connector 144 includes a body 178 having openings 180 for receiving pins (not shown). The body 178 includes a bore 182 sized to receive the bottom-side structural member 122. The body 178 further includes a channel 184 sized to receive straight tongue connectors 148 (FIG. 10), one attached to the front-side structural member 120 and another attached to the radially-extending structural member 126. The pins coupled the straight tongue connectors 148 to the body 178. The channel 184 may be configured to permit the front-side structural member 120 and the radially-extending structural member 126 to pivot or be moved within the channel 184, which in turn permits the shelter 100 to be raised or lowered.

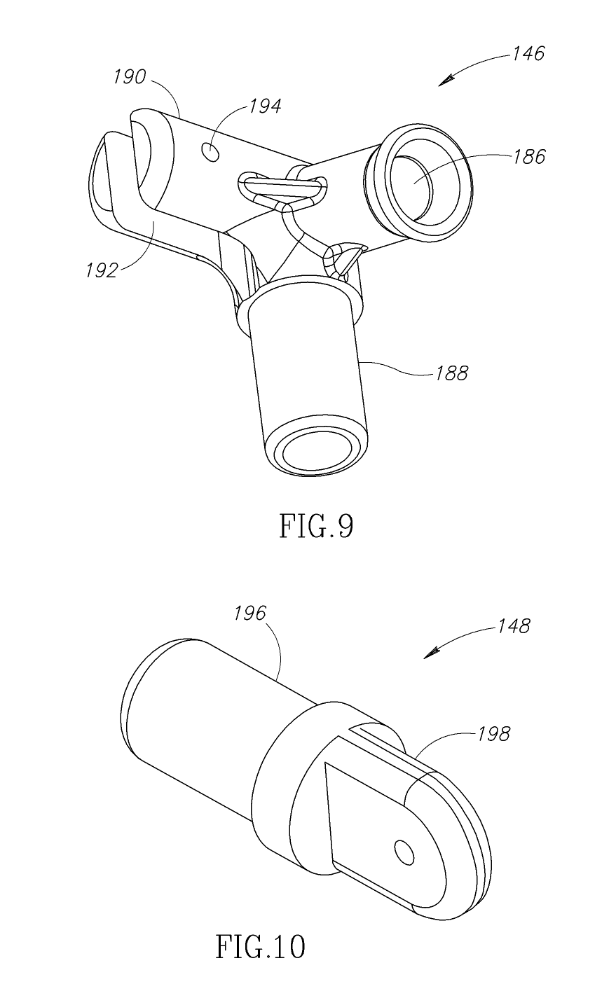

FIG. 9 shows, by way of example, the tri-connector 146 for coupling the front-side structural member 120 and the arch-shaped structural member 124 of the side frame 106 to the top-front structural member 112. In the illustrated embodiment, the tri-connector 146 includes a receiving bore 186, a receiving barrel 188, and a slotted portion 190. The bore 186, barrel 188 and slotted portion 190 may be arranged orthogonally with respect to one another or may be arranged with other angles depending on the configuration of the shelter 100. The slotted portion 190 includes a slot 192 and a pin opening 194, each configured to engage a straight tongue connector 148 (FIG. 10).

FIG. 10 shows the straight connector 148, which is used mainly as an intermediate connector as explained above. The straight connector 148 includes a barrel portion 196 and a tongue portion 198 extending from the barrel portion 196. The straight connector 148 may cooperate with other connectors or may be used independently thereof.

FIG. 11 shows the elbow-shaped saddle connector 150 having a slot 151, a barrel portion 153, and a recessed portion 155. By way of example, the slot 151 receives the straight tongue connector 148, which in turn couples to the diagonal radially-extending member 126, the barrel portion 153 receives the tensioning member 116, and the recessed portion 155 receives the arch-shaped structural member 124.

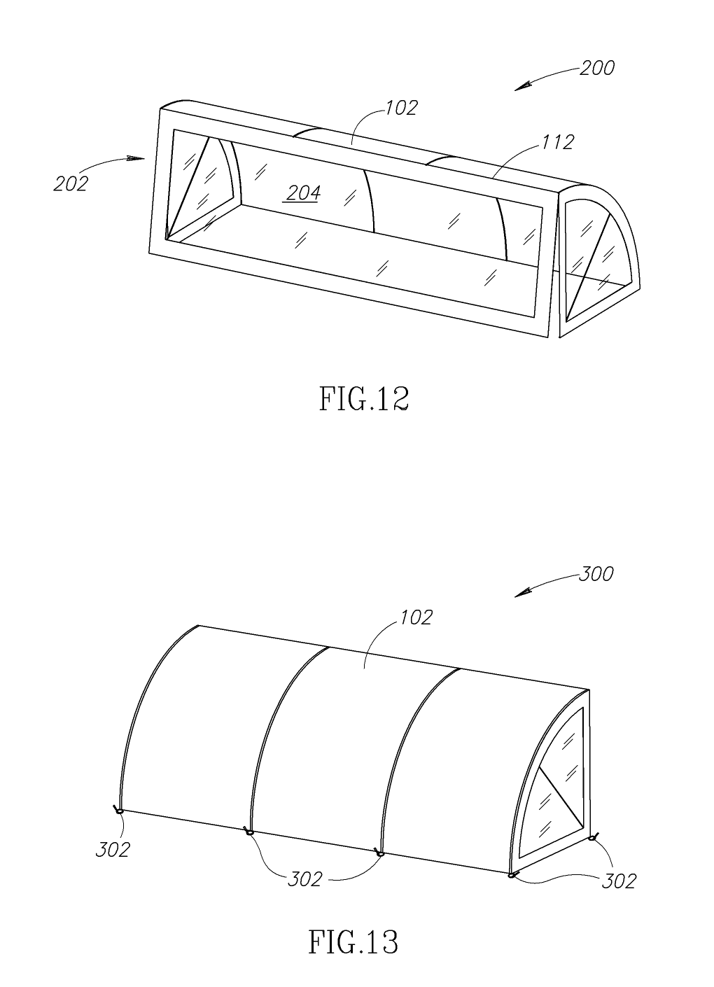

FIG. 12 shows a shelter 200 having a front flap 202 with a see-through portion 204. The shelter 200 is structurally and functionally similar to the shelter 100 described above except for the addition of the front flap 202. Accordingly, the structure of the shelter 200 will not be re-described herein. In the illustrated embodiment, the front flap 202 may be hingedly attached to the top-front structural member 112 or may be stitched or otherwise attached to the cover 102.

FIG. 13 shows a shelter 300 having anchoring devices 302 attached to the various joints of the shelter 300. The shelter 300 is structurally and functionally similar to the shelter 100 described above except for the addition of the anchoring devices 302. Accordingly, the structure of the shelter 300 will not be re-described herein. The anchoring devices 302 may take the form of rods received into the ground with an adjustable cord that attaches to the rod and to reinforce portions of the cover 102 or to one or more of the connectors described above.

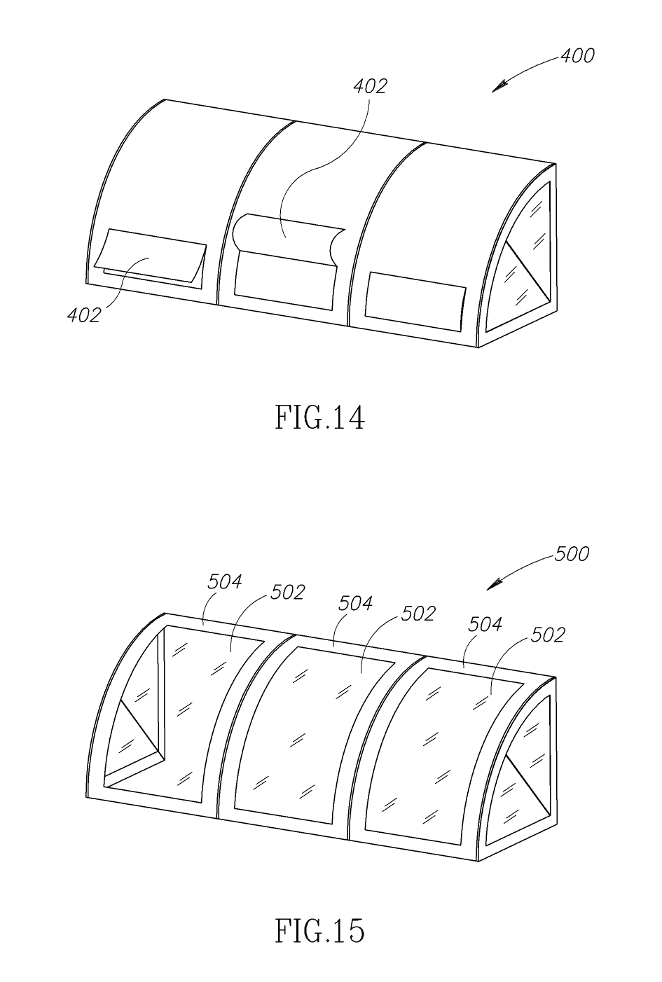

FIG. 14 shows a shelter 400 having rear flaps 402 that may be opened and closed. The flaps 402 may be rolled up and tied to provide additional ventilation through the shelter 400.

FIG. 15 shows a shelter 500 having rear windows 502. In the illustrated embodiment, the rear windows 502 are sized to take up most of the respective panels 504. However, the size of the rear windows 502 may be smaller than illustrated and may be in other configurations besides rectangular.

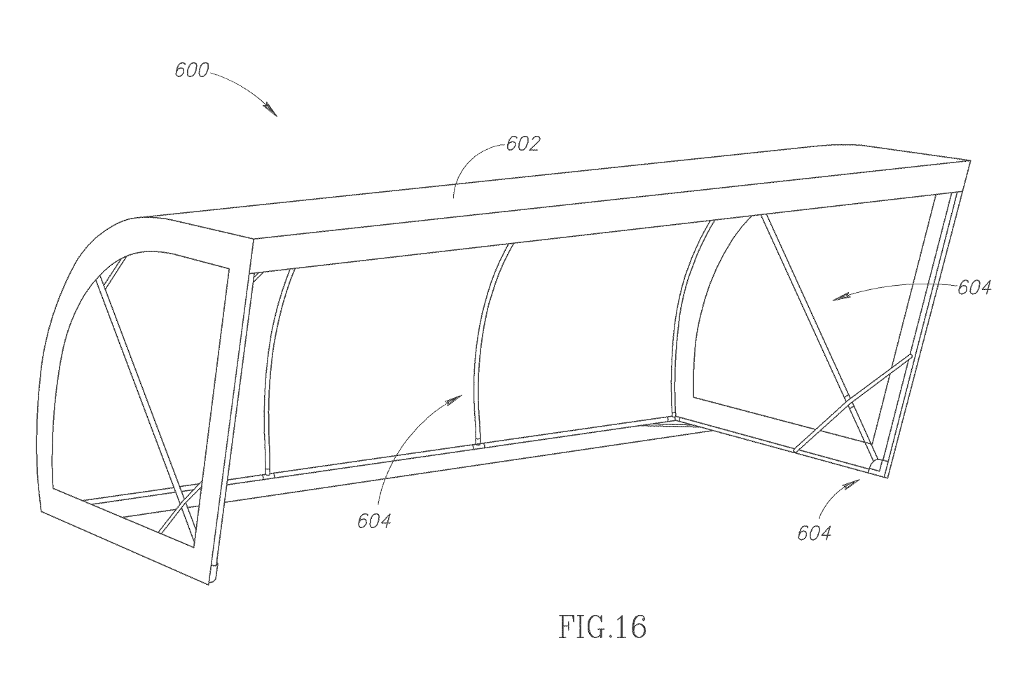

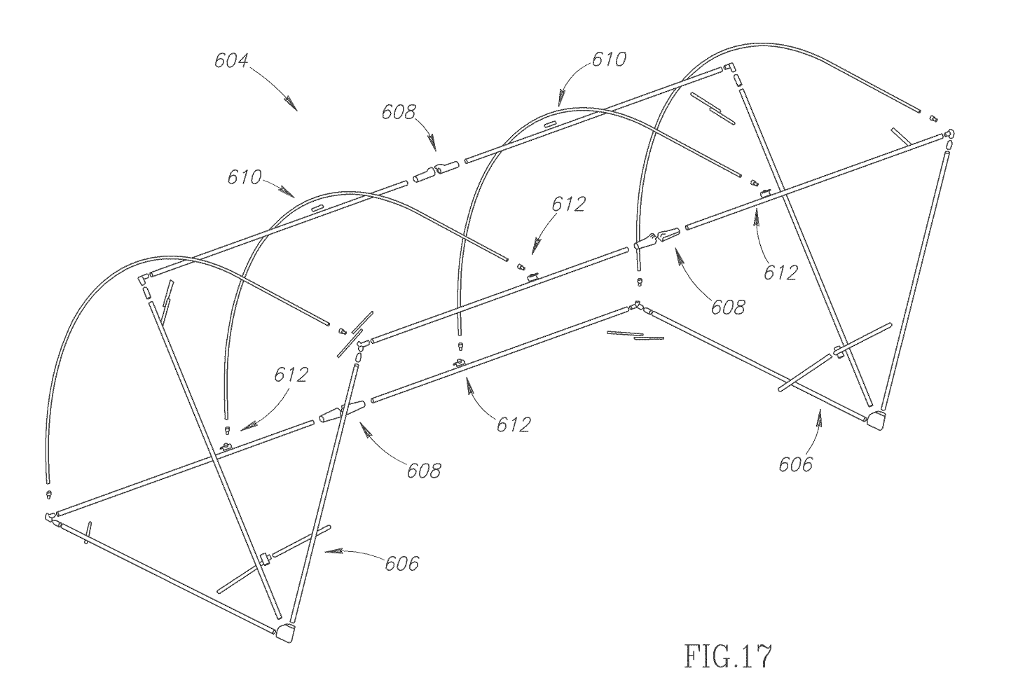

FIGS. 16-18 show another embodiment of a protective shelter 600 having a flexible cover 602 supported by a framework 604 consisting of various support members and connectors. The flexible cover 602 and some of the support members and connectors remain unchanged from the previous embodiment described above and therefore these same components will not be described in detail below. Thus, the following description focuses on the new or revised features as compared to the above-described embodiment. More specifically and referring to FIG. 17, the following description focuses on three new or improved components or assemblies, as follows: a side-brace assembly 606; a connector assembly 608; a cross connector 610; and a sliding T-connector 612.

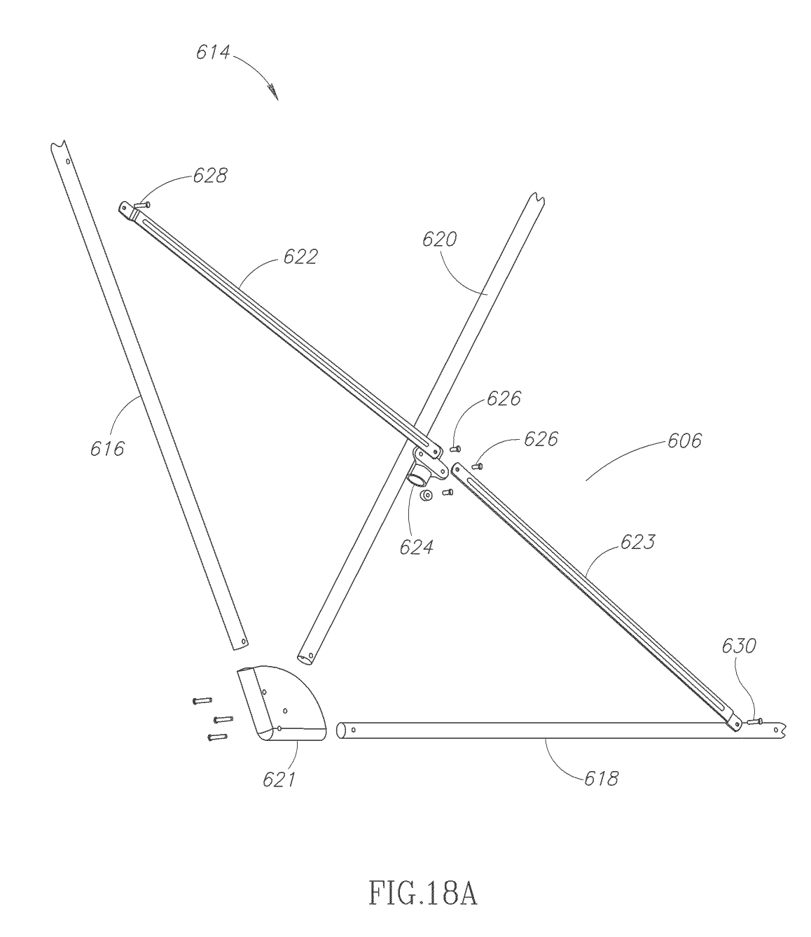

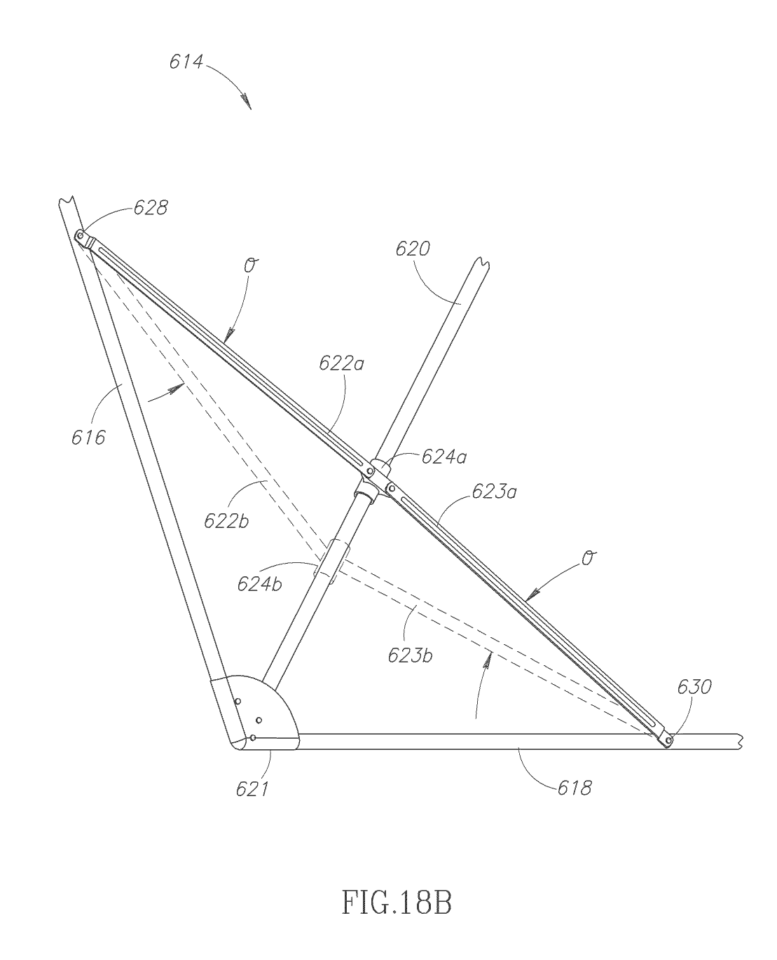

FIG. 18A shows a side frame 614 of the protective shelter 600 according to one embodiment. The side frame 614 includes a front-side structural member 616, a bottom-side structural member 618, a diagonal structural member 620 and the side-brace assembly 606. The structural members 616, 618 and 620 are received in a complex connector 621. For purposes of this description, the front-side structural member 616, the bottom-side structural member 618, the diagonal structural member 620, and the complex connector 621 are identical or at least substantially similar to their counterparts described above, respectively the front-side structural member 120, the bottom-side structural member 122, the diagonal or radially-extending structural member 126, and the complex connector 144.

The new side-brace assembly 606 includes upper compression member 622, lower compression member 623, and a slide connector 624 pivotally coupled 626 to each compression member 622, 623, respectively. In addition, the upper compression member is pivotally coupled 628 to the front-side structural member 616 while the lower compression member 623 is pivotally coupled 630 to the bottom-side structural member 618. The compression members 622, 623 are sized to maintain the diagonal structural member 620 in a desired relationship with the front-side and bottom-side structural members 616 and 618, respectively.

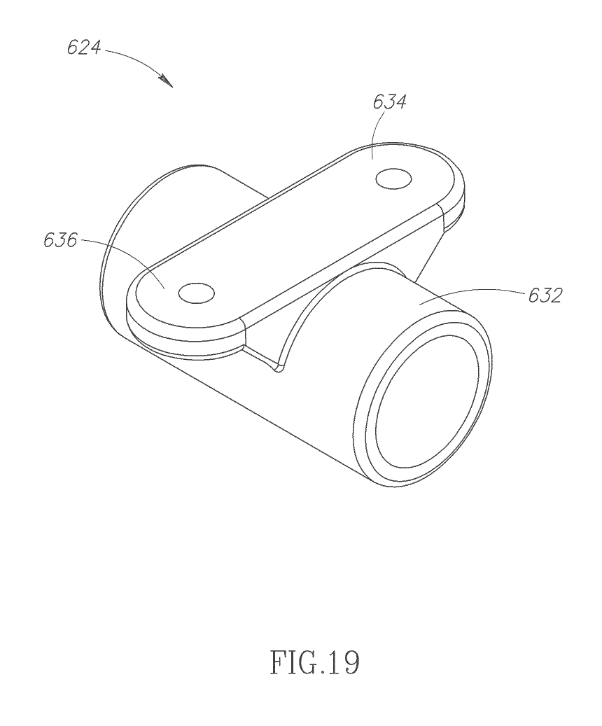

Briefly referring to FIG. 19, the slide connector 624 includes a tube portion 632 integrally formed with or otherwise coupled to ear portions 634, 636. The tube portion 632 includes an inner diameter 638 sized to permit relatively easy sliding along the diagonal structural member 620.

Referring back to FIG. 18A and as the side frame 614 is being set up, the slide connector 624 may be urged (e.g., slid) along the diagonal structural member 620. As this sliding continues, compression forces increase in the compression members 622, 623, which in turn tautens the flexible cover 202 (FIG. 16) especially in a vicinity of the side frames 614.

FIG. 18B shows the side-brace assembly 606 in a maximum compressive position as indicated by use of the reference letter “a” appended to the relevant reference numerals and also in an over-center position as indicated by use of the reference letter “b” appended to the same reference numerals. Thus, as the slide connector 624a reaches a point where the compression members 622a, 623a are perpendicular or substantially perpendicular to the diagonal structural member 620 then a maximum compressive force is achieved in the compression members 622a, 623a. Next, the slide connector 624a may be urged slightly farther down the diagonal member 620 to an over-center position. In the illustrated embodiment, the over-center position is represented by the dashed lines for the compression members 622b, 623b and the dashed circle for the slide connector 624b. In the over-center position the slide connector 624b is in a locked position, meaning that a force urging the slide connector 624b upward along the diagonal member 620 would be required to unlock the side-brace assembly 606. The over-center or locked position for the slide connector 624b may be referred to as being a desired number of degrees over-center as indicated by an angle THETA (shown as the Greek small letter “θ” in the illustrated embodiment). The angle THETA is determined by the angle made between one of the compression members 622b, 623b and one of either the front-side or bottom-side structural member 616 or 630, respectively. In one embodiment, the desired number of degrees over-center for the slide connector 624b is in a range of about one (1) degree to about thirty (30) degrees. In a preferred embodiment, the desired number of degrees over-center is in a range of about two (2) degrees to about five (5) degrees.

The side-brace assembly 606 provides a mechanical advantage in making the flexible cover 602 taut by easily sliding the slide connector 624 relative to the diagonal structural member 620. In addition, the compression forces in the compression members 623, 624 provide added stability for the side frames 614 and provide another load path for any wind loading of the protective shelter 600.

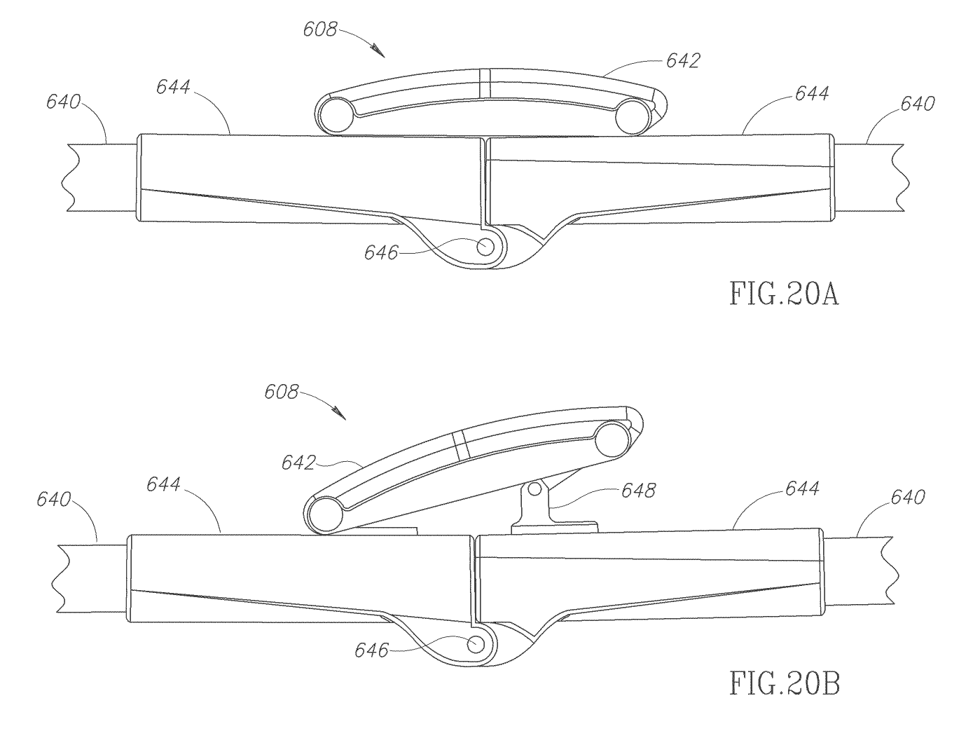

FIGS. 20A and 20B show the connector assembly 608, which provides a mechanically advantaged, quick connection between structural members 640, in which the latter may take the form of any of the elongated top-front structural members 112 (FIG. 2), the elongated bottom-back structural members 114 (FIG. 2), or the tensioning members 116 (FIG. 2). The connector assembly 608 includes a hand-grippable latch 642, two sleeves 644 pivotally coupled 646 together, and a hinge base 648 attached to one of the sleeves 644.

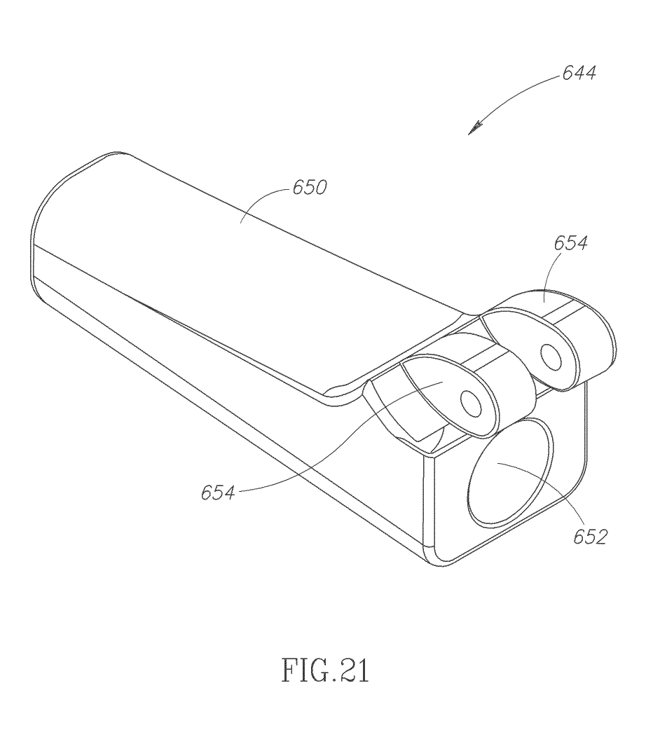

FIG. 21 shows one of the sleeves 644 having a tube receiving body 650 defining a through opening 652 sized to fit over one or more of the structural members 112, 114 or 116. The sleeve 644 includes pivot lugs 654 arranged in an offset arrangement to mesh with complementarily arranged pivot lugs of the mating sleeve 644. A pin or rod (not shown) is received in the pivot lugs 654 once the sleeves 644 are meshed together.

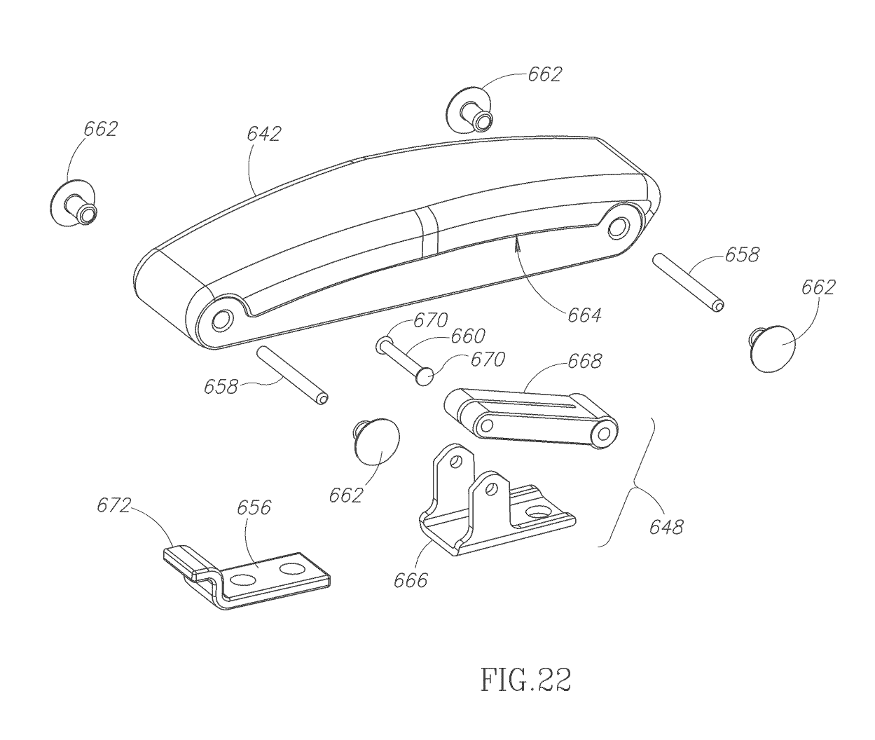

FIG. 22 shows the hand-grippable latch 642, the hinge base 648 attached to one of the sleeves 644 (FIG. 21), a first sleeve attachment plate 656, latch end pivot rods 658, a hinge base pivot rod 660 and a plurality of end caps 662. The latch 642 is sized and contoured to be readily grippable by different sized hands. The latch 642 may have a lip 664 that allows to easily release the latch 642 from its connecting configuration (FIG. 20A). The hinge base 648 includes a second sleeve attachment plate 666 and a link 668. The attachment plate 666 is fixed to one of the sleeves 644 (FIG. 21) and pivotally coupled to the link 668 by way of the hinge base pivot rod 660, which may also include end caps 670. In turn, the link 668 is pivotally coupled to the latch 642 by way of one of the latch end pivot rods 658. The first sleeve attachment plate 656 is fixed to the other sleeve 644. The first sleeve attachment plate 656 includes an overhanging L-shaped catch portion 672 under which the other latch end pivot rod 658 is placed when the connector assembly 608 is assembled. The L-shaped catch portion 672 permits the rod 658 to move laterally as the latch 642 is rotated from its locked configuration (FIG. 20A) to its open configuration (FIG. 20B). When in the latter configuration, the latch 642 may be urged to release the pivot rod 658 from under the L-shaped catch portion 672. Once the latch 642 has been removed then the sleeves 644 may be slid off the structural members during disassembly of the protective shelter 600 (FIG. 16). In one embodiment, the connector assembly 608 may be used in place of the slide-locking bent tongue connector 138 (FIG. 5) described in the initial embodiment herein.

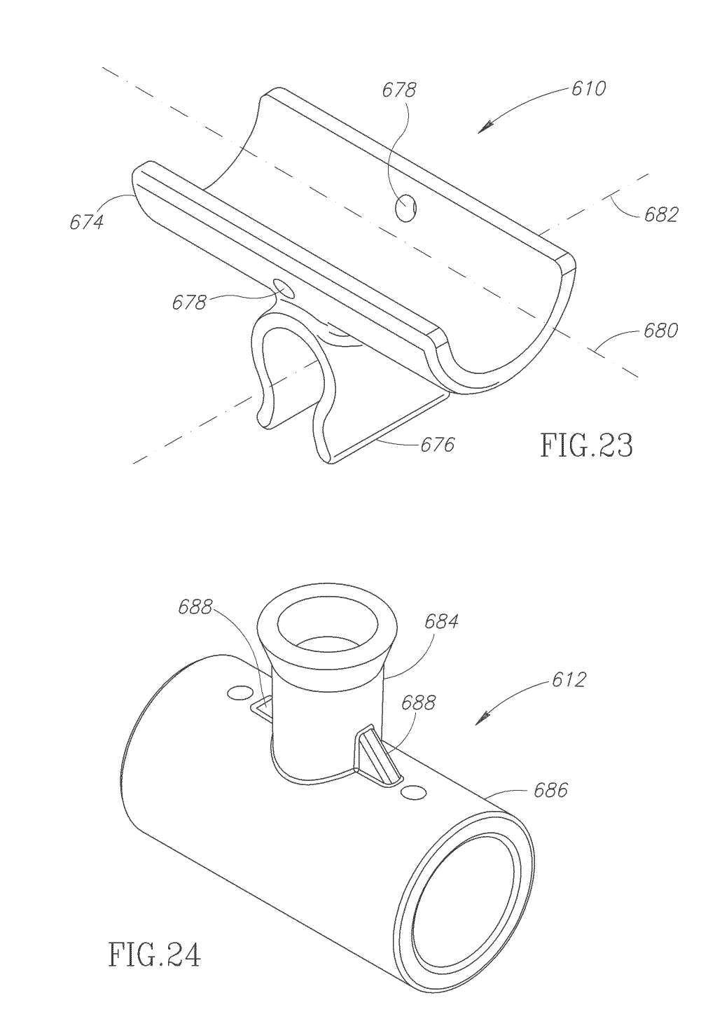

FIG. 23 shows the cross connector 610, which may be employed in place of the snap saddle 142 (FIG. 7) described in the initial embodiment herein. The cross connector 610 includes a semicircular portion 674 configured to receive any of the structural members 112, 114 or 116 (FIG. 2), respectively, and further includes an approximate horseshoe-shaped portion 676 configured to snap onto any one of the intermediate members 136 (FIG. 2). The portions 674, 676 may be coupled together or integrally formed, such as molded as a single part. The semicircular portion 674 includes openings 678 to receive fasteners for securing the cross connector 610 to one of the structural members 112, 114 or 116. In the illustrated embodiment, the portion 674 is formed about a first axis 680 while the portion 676 is formed about a second axis 682. Preferably, the axes 680 and 682 are arranged approximately perpendicular or perpendicular to one another.

FIG. 24 shows the sliding T-connector 612, which may be employed in place of the snap T-connector 140 (FIG. 6) described in the initial embodiment herein. In one embodiment, the sliding T-connector 612 is used to couple the intermediate members 136 (FIG. 2) to the top-front structural member 112 and to the bottom-back structural member 114 (FIG. 2). The sliding T-connector 612 includes a pole or rod coupling portion 684 for engaging the intermediate member 136 (FIG. 2) and a tubular portion 686 for engaging the structural members 112, 114 (FIG. 2), respectively. For additional structural support, the sliding T-connector 612 may include gussets or ribs 688 that extend the portions 684 and 686, respectively.

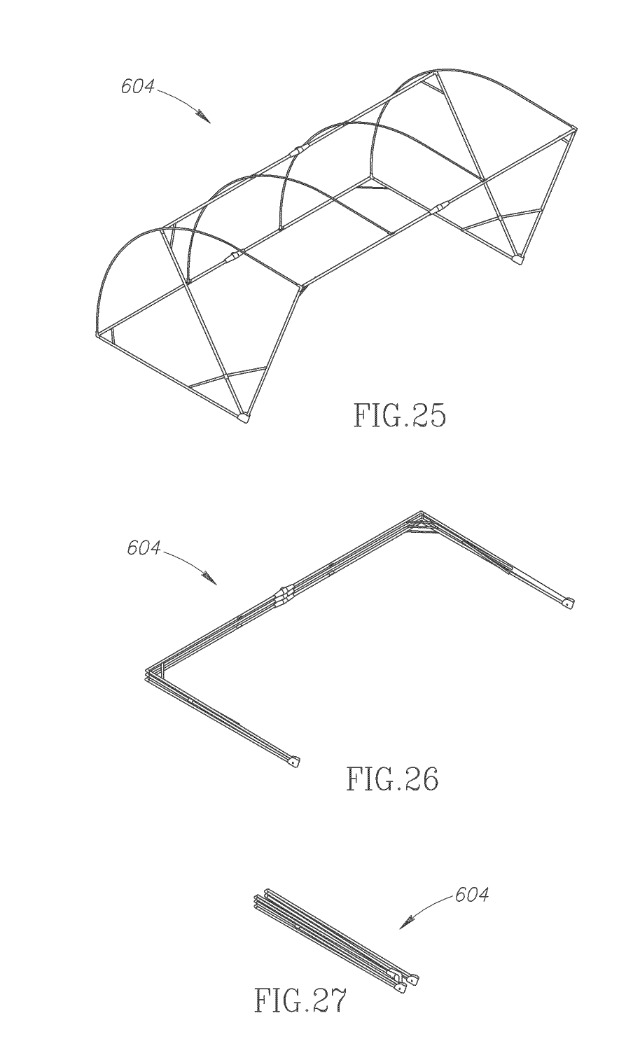

FIGS. 25-27 show the framework 604 of the protective shelter 600 in a variety of configurations. By way of example, FIG. 25 shows the framework 604 in a fully setup or assembled configuration; FIG. 26 shows the framework 604 in a first folded or first disassembled configuration; and lastly FIG. 27 shows the framework 604 in a fully disassembled or portable configuration.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined by reference to the claims that follow.

The embodiments of the invention in which an exclusive property or privilege is claimed are defined as follows:

1. A protective shelter comprising:
an arcuate-shaped cover made from a flexible material, the cover extending from a first side portion to a second side portion;
a framework having two side frame assemblies and structural members extending from the one side frame assembly to the other side frame assembly, each side frame assembly having a diagonal member spaced from front-side and bottom-side structural members, the framework assemble-able to make the cover taut; and
at least one side brace assembly having two compression members coupled to a slide connector that is slideably moveable along the diagonal member, the slide connector moveable from an unlocked position to an locked position.

2. The protective shelter of claim 1, further comprising a hub connector configured to receive the diagonal member as well as the front-side and bottom-side structural members.

3. The protective shelter of claim 1, wherein the over-center position of the slide connector includes the slide connector positioned in a range of about one degree to about ten degrees as determined by an angle made between one of the compression members and one of either the front-side or bottom-side structural member.

4. The protective shelter of claim 1, wherein the slide connector includes a tube portion configured to slideably receive the diagonal member.

5. A protective shelter comprising:
an arcuate-shaped cover made from a flexible material, the cover extending from a first side portion to a second side portion;
a framework having two side frame assemblies and structural members extending from the one side frame assembly to the other side frame assembly, the framework further having, the framework assembleable to make the cover taut; and
at least one connector assembly having abutting sleeves, each sleeve configured to receive one of the structural members, the sleeves pivotally coupled together, the connector assembly further having a grippable latch with a first end portion pivotally coupled to one of the sleeves and a second end portion pivotally coupled to the other sleeve.

6. The protective shelter of claim 5, wherein the first end portion is pivotally coupled to a link, and wherein the link is pivotally coupled to a hinge base fixed to the one of the sleeves.

7. The protective shelter of claim 5, wherein the latch is moveable from a locked configuration to an open configuration.

8. The protective shelter of claim 5, further comprising an attachment plate having an overhanging portion configured to releasably receive a pivot rod coupled to the latch.

9. The protective shelter of claim 8, wherein the latch is removable from under the overhanging portion when the latch is in an open configuration.

10. A protective shelter comprising:
an arcuate-shaped cover made from a flexible material, the cover extending from a first side portion to a second side portion;
a framework having two side frame assemblies and structural members extending from the one side frame assembly to the other side frame assembly, each side frame assembly having at least one intermediate member in approximately the arcuate-shape of the cover, the framework assembleable to make the cover taut; and
at least one cross connector having a first channel attachable to one of the structural members and a second channel biasly attachable to the at least one intermediate member.

11. The protective shelter of claim 10, wherein the first channel having a first longitudinal axis and the second channel having a second longitudinal axis, the respective axes arranged approximately perpendicular to each other.

12. The protective shelter of claim 10, wherein the first channel is fastenable to the structural member.

13. The protective shelter of claim 10, wherein the second channel includes a necked down portion configured to snap over the at least one intermediate member.

14. A connector assembly comprising:
a first sleeve configured to receive a first structural member;
a second sleeve configured to receive second structural member, the second sleeve abutting the first sleeve and pivotally coupled thereto; and
a grippable latch with a first end portion pivotally coupled to one of the sleeves and a second end portion pivotally coupled to the other sleeve.

15. The connector assembly of claim 14, wherein the structural members are tubular.

16. The connector assembly of claim 14, wherein the latch is moveable from a locked configuration to an open configuration.

17. The connector assembly of claim 14, further comprising an attachment plate having an overhanging portion configured to releasably receive a pivot rod coupled to the latch.

18. The connector assembly of claim 17, wherein the latch is removable from under the overhanging portion when the latch is in an open configuration.

19. A method of assembling a protective shelter, the method comprising:
fixing an elongated top-front structural member to the front edge of the flexible cover and an elongated bottom-back structural member to the back edge of the flexible cover, the top-front and bottom-back structural members configured to tension the cover in a direction substantially parallel to a longitudinal axis of at least one of the top-front and bottom-back structural members;
coupling a first arcuate-shaped structural member to one side edge of the cover and to the top-front and bottom-back structural members;
coupling a second arcuate-shaped structural member to the other side edge of the cover and to the top-front and bottom-back structural members;
rotating the top-front structural member away from the bottom-back structural member about a shelter rotation axis extending horizontally through first and second central hubs corresponding to the respective first and second arcuate-shaped structural members; and
coupling a tensioning member to the flexible cover.

20. The method of claim 19, further comprising moving a slide connector along a diagonal member to generate compression in two compression members coupled thereto.

21. The method of claim 20, wherein moving the slide connector includes moving the slide connector from an unlocked position to a locked position.
